(19) United States
(12) Patent Application Publication
(10) Pub. No.: US 2023/0004063 A1
(43) Pub. Date: Jan. 5, 2023

(54) Ball Bearing Suspension Arrangement for Camera with Tilt Actuator

(71) Applicant: Apple Inc., Cupertino, CA (US)

(72) Inventors: Hiran R Rathnasinghe, Fremont, CA (US); Nicholas D Smyth, San Jose, CA (US)

(73) Assignee: Apple Inc., Cupertino, CA (US)

(21) Appl. No.: 17/809,508

(22) Filed: Jun. 28, 2022

Related U.S. Application Data
(60) Provisional application No. 63/217,250, filed on Jun. 30, 2021.

(51) Int. Cl. G03B 5/00; G03B 17/12; G03B 17/04

(52) U.S. Cl. CPC G03B 5/00; G03B 17/12; G03B 17/04; G03B 2205/0069; G03B 2205/0023

(57) ABSTRACT

Various embodiments include a camera with a ball bearing suspension arrangement that suspends one or more tiltable structures. In some embodiments, the camera may include an optical element, an image sensor, an actuator arrangement, and the ball bearing suspension arrangement. The actuator arrangement may include a tilt actuator configured to tilt one or more tiltable structures about a tilt axis. The ball bearing arrangement may suspend the tiltable structure(s) from a base structure and allow motion of the tiltable structure(s) enabled by the tilt actuator. In various embodiments, the ball bearing suspension arrangement may include a ball bearing that is positioned at a different height, along the tilt axis, than one or more other ball bearings of the ball bearing suspension arrangement.

### BACKGROUND

This application claims benefit of priority to U.S. Provisional Application Ser. No. 63/217,250, entitled “Ball Bearing Suspension Arrangement for Camera with Tilt Actuator,” filed Jun. 30, 2021, and which is hereby incorporated herein by reference in its entirety.

### TECHNICAL FIELD

This disclosure relates generally to architecture for a camera with a ball bearing suspension arrangement that suspends one or more tiltable structures.

### DESCRIPTION OF THE RELATED ART

The advent of small, mobile multipurpose devices such as smartphones and tablet or pad devices has resulted in a need for high-resolution, small form factor cameras for integration in the devices. Some small form factor cameras may incorporate folded optics including one or more light path folding elements such as prisms or mirrors to change the direction of the optical path of an image so as to redirect light to an image sensor that is positioned out of the natural path of the light representing the image to be captured. Some such systems include optical image stabilization (OIS) and/or autofocus (AF) mechanisms that may sense and react to external excitation/disturbance by adjusting position of the light path folding elements and/or optical lens assembly on an X and/or Y axis in an attempt to compensate for unwanted motion of the camera unit or lens. Some small form factor cameras may include a ball bearing suspension mechanism to support one or more tiltable structures including the light path folding element or elements.

### BRIEF DESCRIPTION OF THE DRAWINGS

FIG. 1 illustrates a perspective view of an example folded optics arrangement that may be included in a camera configured with a ball bearing suspension arrangement, in accordance with some embodiments.

FIG. 2 illustrates a perspective view of an example camera with folded optics that may be equipped with a ball bearing suspension arrangement, in accordance with some embodiments.

FIG. 3 illustrates a perspective view of an example actuator arrangement of an example camera that may be equipped with a ball bearing suspension arrangement, in accordance with some embodiments.

FIG. 4 illustrates a perspective view of an example bearing suspension arrangement that may be included in a camera with folded optics, in accordance with some embodiments.

FIGS. 5A-5B illustrate top views of example bearing suspension arrangements that may be included in a camera with folded optics. FIG. 5A shows an arrangement having four ball bearings. FIG. 5B shows another arrangement including three ball bearings, in accordance with some embodiments.

FIGS. 6A-6B illustrate perspective views of the relative positions of bearings in example bearing suspension arrangements that may be included in a camera with folded optics. FIG. 6A shows an arrangement having four ball bearings. FIG. 6B shows another arrangement of three ball bearings, in accordance with some embodiments.

FIGS. 7A-7B illustrate cross-sectional views of example folded optics arrangements that may accommodate a ball bearing suspension arrangement. FIG. 7A shows a view of an arrangement that may be used, e.g., with the ball bearing suspension arrangement shown in FIG. 5A and/or FIG. 6A. FIG. 7B shows a modified wall thickness for accommodating a ball bearing suspension arrangement, in accordance with some embodiments.

FIG. 8 illustrates a schematic representation of an example device that may include a camera with folded optics that may be equipped with a ball bearing suspension arrangement, in accordance with some embodiments.

FIG. 9 illustrates a schematic block diagram of an example computer system that may include a camera with folded optics that may be equipped with a ball bearing suspension arrangement, in accordance with some embodiments.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

“Comprising.” This term is open-ended. As used in the appended claims, this term does not foreclose additional structure or steps. Consider a claim that recites: “An apparatus comprising one or more processor units . . . .” Such a claim does not foreclose the apparatus from including additional components (e.g., a network interface unit, graphics circuitry, etc.).

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. § 112(f) for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue. “Configure to” may also include adapting a manufacturing process (e.g., a semiconductor fabrication facility) to fabricate devices (e.g., integrated circuits) that are adapted to implement or perform one or more tasks.

“First,” “Second,” etc. As used herein, these terms are used as labels for nouns that they precede, and do not imply any type of ordering (e.g., spatial, temporal, logical, etc.). For example, a buffer circuit may be described herein as performing write operations for “first” and “second” values. The terms “first” and “second” do not necessarily imply that the first value must be written before the second value.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While in this case, B is a factor that affects the determination of A, such a phrase does not foreclose the determination of A from also being based on C. In other instances, A may be determined based solely on B.

It will also be understood that, although the terms first, second, etc. may be used herein to describe various elements, these elements should not be limited by these terms. These terms are only used to distinguish one element from another. For example, a first contact could be termed a second contact, and, similarly, a second contact could be termed a first contact, without departing from the intended scope. The first contact and the second contact are both contacts, but they are not the same contact.

The terminology used in the description herein is for the purpose of describing particular embodiments only and is not intended to be limiting. As used in the description and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

### DETAILED DESCRIPTION

Some embodiments include camera equipment outfitted with a bearing suspension arrangement for suspending one or more tiltable structures according to various embodiments. In various embodiments, a camera may include one or more optical elements, an image sensor, an actuator arrangement, and the ball bearing suspension arrangement. The optical element(s) may include, for example, a lens, a prism, and/or a mirror. The actuator arrangement may include the tiltable structure(s) and a tilt actuator. In some embodiments, the tiltable structure(s) may include a carrier to which the optical element or the image sensor may be fixedly coupled. The tilt actuator may be configured to tilt the tiltable structure(s) about a tilt axis. In various embodiments, compact camera modules include actuators to deliver functions such as autofocus (AF) and/or optical image stabilization (OIS). One non-limiting approach to delivering a very compact actuator for AF and/or OIS is to use a voice coil motor (VCM) actuator.

According to various embodiments, the ball bearing suspension arrangement may suspend the tiltable structure(s) from a base structure, and may allow motion of the optical element(s) or the image sensor enabled by the tilt actuator. The ball bearing suspension arrangement may include a set of ball bearings arranged to allow tilt motion of the tiltable structure(s) about the tilt axis. In some embodiments, the set of ball bearings may include a ball bearing that is at a different height relative to other ball bearings in set of ball bearings. In some embodiments, the set of ball bearings may include a first ball bearing and a second ball bearing positioned along an axis, and the axis may intersect a first plane that is orthogonal to the tilt axis. Furthermore, the set of ball bearings may include a third ball bearing. The first ball bearing, the second ball bearing, and the third ball bearing may be positioned along a second plane that intersects the first plane.

In some other camera systems, four or more ball bearings may be positioned in a single plane orthogonal to the tilt axis. However, in such an arrangement, any small difference in ball size, or for example differences in positional height as a result of imperfect manufacturing tolerances for example in any material surrounding the ball bearings, may reduce the stability of a tiltable structure as it rests and/or rotates on the ball bearings. In various embodiments disclosed here, the set of ball bearings may have a number of ball bearings (e.g., three ball bearings) arranged to increase stability of the tiltable structure(s) in suspension by the set of ball bearings and during rotating about the tilt axis. For example, one of the ball bearings may be positioned higher on the tilt axis relative to the other ball bearings. As a result, and in accordance with some embodiments, the plane formed by ball bearings is not orthogonal to the tilt axis. According to some embodiments, this placement of the ball bearings may allow for additional room within a camera housing for more parts and/or upgraded components of a camera module, as further discussed herein.

Various embodiments are discussed herein within the context of a folded optics arrangement. However, it should be understood that various embodiments of the bearing suspension arrangement may be used in various different types of cameras, including those that do not have a folded optics arrangement those that have a different folded optics arrangement than the ones used as examples herein.

Reference will now be made in detail to embodiments, examples of which are illustrated in the accompanying drawings. In the following detailed description, numerous specific details are set forth in order to provide a thorough understanding of the present disclosure. However, it will be apparent to one of ordinary skill in the art that some embodiments may be practiced without these specific details. In other instances, well-known methods, procedures, components, circuits, and networks have not been described in detail so as not to unnecessarily obscure aspects of the embodiments.

Described herein are embodiments of a camera with folded optics and a bearing suspension arrangement for suspending one or more tiltable structures according to various embodiments. The arrangements discussed throughout generally comprise at least a first ball bearing, and a second ball bearing positioned closer, relative to the first ball bearing to an object side of a light path folding element.

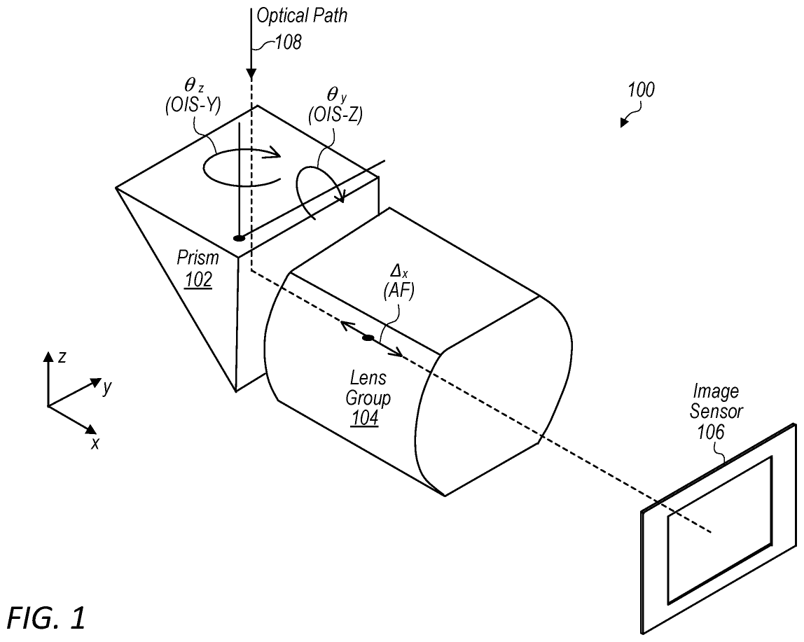

FIG. 1 shows a generalized example of a perspective view of an example folded optics arrangement that may be included in a camera 100 with folded optics configured with a ball bearing suspension arrangement, in accordance with some embodiments. The example X-Y-Z coordinate system shown in FIG. 1 is used to discuss aspects of embodiments described throughout this disclosure.

In various embodiments, the camera 100 may include a light path folding element (e.g., prism 102), a lens group 104, and an image sensor 106 (and/or an image sensor package). The lens group 104 may include one or more lens elements. In some embodiments, the lens group 104 may be located between the prism 102 and the image sensor 106. The prism 102 and the lens group 104 may form a folded optics arrangement (e.g., a single fold optics arrangement as indicated in FIG. 1) through which light passes before reaching the image sensor 106. Light may follow an optical path 108 that is folded by prism 102 such that the light is directed towards the lens group 104, passes through the lens group 104, and then reaches the image sensor 106. In some examples, light may enter an object side of the prism 102 along the Z-axis. The prism 102 may redirect the light to propagate along the X-axis (which may be parallel to an optical axis defined by the lens group 104), e.g., such that the light exits a lens group facing side of the prism 102 towards the lens group 104. The light may pass through the lens group 104 and continue propagating along the X-axis towards the image sensor 106 (which may be vertically oriented, e.g., such that the image sensor 106 defines a plane that is orthogonal to the X-axis and/or the optical axis defined by the lens group 104). The prism 102, the lens group 104, and/or the image sensor 106 may be positioned along a common axis (e.g., the X-axis, the optical axis defined by the lens group 104, etc.). According to some examples, the optical path 108 may be contained within a plane (e.g., the X-Z plane), and the image sensor 106 may extend along a different plane (e.g., the Y-Z plane).

In some embodiments, the object side of the prism 102 may extend along the X-Y plane. Furthermore, the prism 102 may include a pair of opposing lateral sides that each extend along the X-Z plane, a lens group facing side that extends along the Y-Z plane, and a reflecting surface side that is angled relative to one or more of the other sides of the prism 102. For example, the reflecting surface side of the prism 102 may include a reflective surface that is angled so as to redirect light received from the object side of the prism 102 towards the lens group 104 (via the lens group facing side of the prism 102) and the image sensor 106, as discussed above.

While the light path folding elements are shown in various figures as comprising prisms (e.g., prism 102), the camera systems and/or folded optics arrangements described herein may include any suitable light path folding element (e.g., a mirror or the like) or combination of elements. In some embodiments, one or more of the light path folding elements may also act as a lens element (or combination of lens elements). For example, one or more lens elements (e.g., other than those of the lens group 104) may be integrated with the prism 102 such that the prism 102 acts as a lens element. Additionally, or alternatively, the 102 may be shaped such that the prism 102 acts as a lens element.

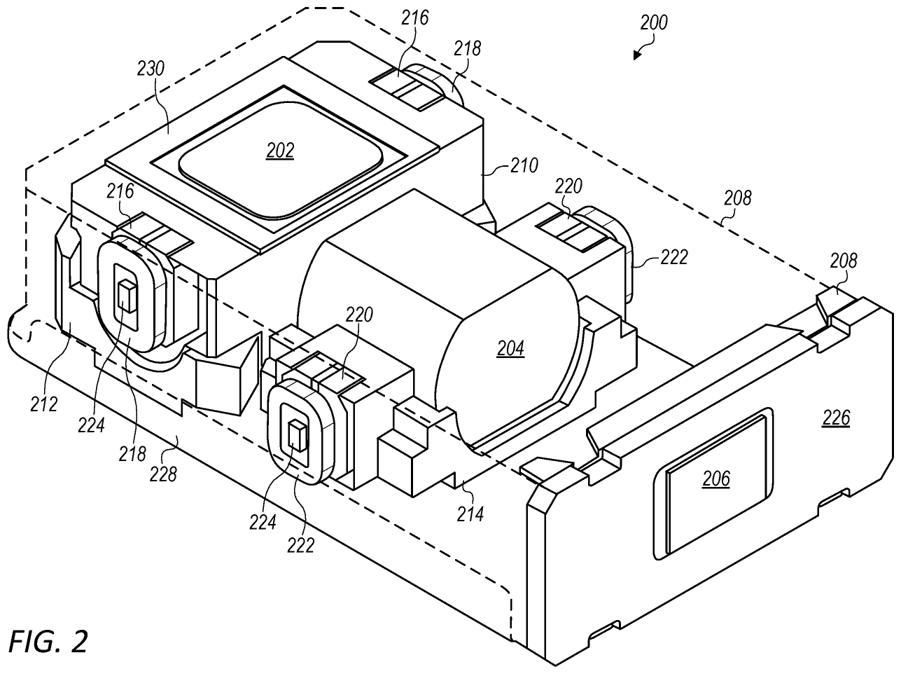

In various embodiments, the prism 102 and/or the lens group 104 may be coupled with one or more actuators (e.g., as discussed herein with reference to at least FIGS. 2-8A and 9) configured to move the prism 102 and/or the lens group 104 to provide optical image stabilization (OIS) and/or autofocus (AF) functionality. For example, the prism 102 may be coupled with actuator(s) configured to tilt or otherwise move the prism 102. As indicated in FIG. 1, in various embodiments the actuator(s) may be configured to tilt the prism 102 about multiple axes to provide OIS functionality. An axis about which the prism 102 may be tilted may also be referred to as a “tilt axis” herein. In some embodiments, the actuator(s) may tilt the prism 102 about the Z-axis (tilt indicated in FIG. 1 as θ_{z}) to provide OIS-Y movement (e.g., movement that shifts the image projected onto the image sensor 106 in one or more directions parallel to the Y-axis). Additionally, or alternatively, the actuator(s) may tilt the prism 102 about the Y-axis (tilt indicated in FIG. 1 as θ_{y}) to provide OIS-Z movement (e.g., movement that shifts the image projected onto the image sensor 106 in the Z-axis). In various embodiments, the actuator(s) may be configured to translate or otherwise move the lens group 104. For example, the actuator(s) may linearly translate the lens group 104 along the X-axis (translation indicated in FIG. 1 as Δₓ) to provide AF movement.

FIG. 2 illustrates a perspective view of an example camera 200 with folded optics that may be equipped with a ball bearing suspension arrangement, in accordance with some embodiments. As will be discussed in further detail below, the camera 200 may include actuators that enable optical elements to move to provide OIS and/or AF functionality, e.g., as indicated with reference to the camera 100 in FIG. 1.

According to some embodiments, the camera 200 may include a prism 202, a lens group 204 (which may include one or more lenses, e.g., within a lens barrel), and an image sensor 206 (and/or image sensor package). In various embodiments, the prism 202, the lens group 204, and the image sensor 206 may form a folded optics arrangement that may be similar to, or the same as, the folded optics arrangement formed by the prism 102, the lens group 104, and the image sensor 106, respectively, in FIG. 1.

In various embodiments, the camera 200 may include a bearing suspension arrangement and/or an actuator arrangement that may be used for controlled movement of one or more light path folding elements (e.g., prism 202) and/or the lens group 204. In some embodiments, the bearing suspension arrangement may include a base structure 208, a Y stage 210, a Z stage 212, and/or an X stage 214. The base structure 208 (and/or the image sensor 206) may be in a fixed position relative to movement of the Y stage 210, a Z stage 212, and/or an X stage 214. The bearing suspension arrangement may be coupled with the prism 202 and/or the lens group 204, and may allow the prism 202 and the lens group 204 to move in multiple directions relative to the image sensor 206. For example, the prism 202 may be coupled with the Y stage 210 and the Z stage 212, which may enable movement of the prism 202 in two degrees of freedom (2DOF). Additionally, or alternatively, the lens group 204 may be coupled with the X stage 214, which may enable movement of the lens group 204 in one degree of freedom (1DOF).

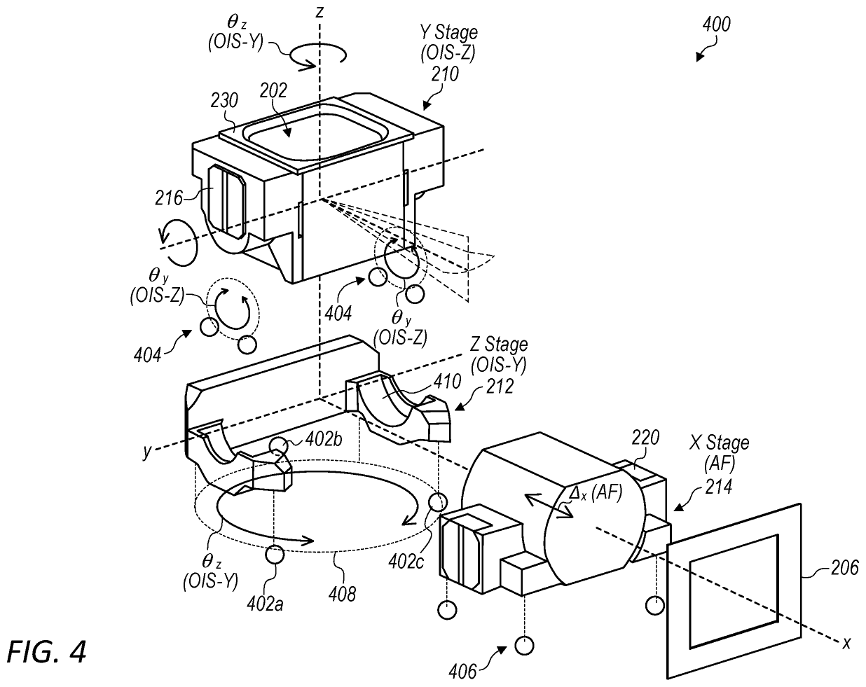

In some embodiments, the Z stage 212 may rest on (or otherwise be disposed above) a floor portion of the base structure 208, and may be configured to tilt (and/or rotate) about the Z-axis, e.g., via Z-tilt ball bearings disposed between the Z stage and the floor portion of the base structure 208, as discussed in further detail herein with reference to FIG. 4. According to some examples, the Z-axis tilt movement may be used to provide the OIS-Y movement previously mentioned with reference to FIG. 1.

In some embodiments, the Y stage 210 may rest on (or otherwise be disposed above) the Z stage 212, and may be configured to tilt (and/or rotate) about the Y-axis, e.g., via Y-tilt ball bearings disposed between the Y stage 210 and the Z stage 212, as discussed in further detail herein with reference to FIG. 4. According to some embodiments, the Y-axis tilt movement may be used to provide the OIS-Z movement previously mentioned with reference to FIG. 1. Furthermore, in some embodiments, the Y stage 210 may be configured to tilt about the Z-axis together with the Z stage 212, e.g., due to Z-axis tilt movement of the Z stage 212. According to various embodiments, the prism 202 may be coupled to the Y stage 210, e.g., such that the prism 202 moves together with the Y stage 210.

In some embodiments, the X stage 214 may rest on (or otherwise be disposed above) a floor portion of the base structure 208, and may be configured to translate along the X-axis, e.g., via X-translation ball bearings disposed between the X stage 214 and the floor portion of the base structure 208, as discussed in further detail herein with reference to FIG. 4. According to some embodiments, the X-axis translation movement may be used to provide the AF movement previously mentioned with reference to FIG. 1. In various embodiments, the lens group 204 may be coupled to the X stage 214, e.g., such that the lens group 204 moves together with the X stage 214.

In various embodiments, the actuator arrangement may provide for moving the prism 202 and/or the lens group 204 (e.g., via movement of the Y stage 210, the Z stage 212, and/or the X stage 214, as described herein) to provide OIS and/or AF movement. In some embodiments, the actuator arrangement may comprise one or more voice coil motor (VCM) actuators. The VCM actuator(s) may include one or more magnets and one or more coils. The magnets and coils may magnetically interact (e.g., when electrical current is provided to the coils) to produce Lorentz forces that move the prism 202 and/or the lens group 204, e.g., via controlled movement in directions allowed by the stages of the bearing suspension arrangement.

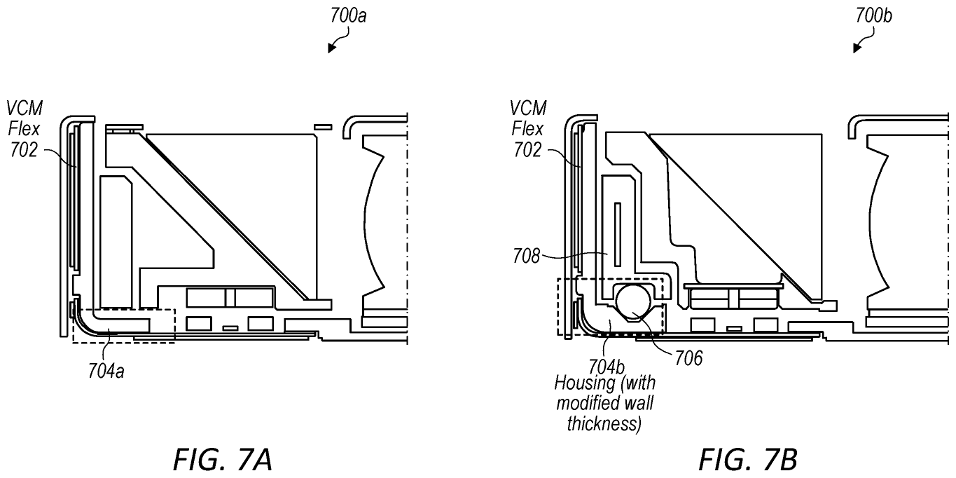

In some embodiments, the actuator arrangement may include an OIS-Z VCM actuator (e.g., to provide OIS-Z movement), an OIS-Y movement (e.g., to provide OIS-Y movement), and an AF actuator (e.g., to provide AF movement). For example, the OIS-Z VCM actuator may include one or more OIS-Z magnets 216 and one or more OIS-Z coils 218, e.g., as indicated in FIG. 2. The OIS-Z magnet(s) 216 may be attached to the Y stage 210. Furthermore, the OIS-Z coil(s) 218 may be coupled with the base structure 208 (e.g., at lateral side portion(s) of the base structure 208). In some embodiments, the OIS-Z coil(s) 218 may be attached to the base structure 208. In some embodiments, the OIS-Z coil(s) 218 may be coupled with the base structure 208 via a flex circuit (e.g., the flex circuit 702 in FIGS. 7A-7B). According to some non-limiting embodiments, the flex circuit may include a plurality of bend portions at which the flex circuit is folded to wrap around a portion of the base structure 208, and a plurality of straight portions. The OIS-Z coil(s) 218 may be attached to one or more of the straight portions of the flex circuit, in some embodiments. An OIS-Z magnet 216 and a corresponding OIS-Z coil 218 may be positioned proximate one another so that they magnetically interact with each other to tilt the prism 202 together with the Y stage 210 about Y-axis, to provide OIS-Z movement.

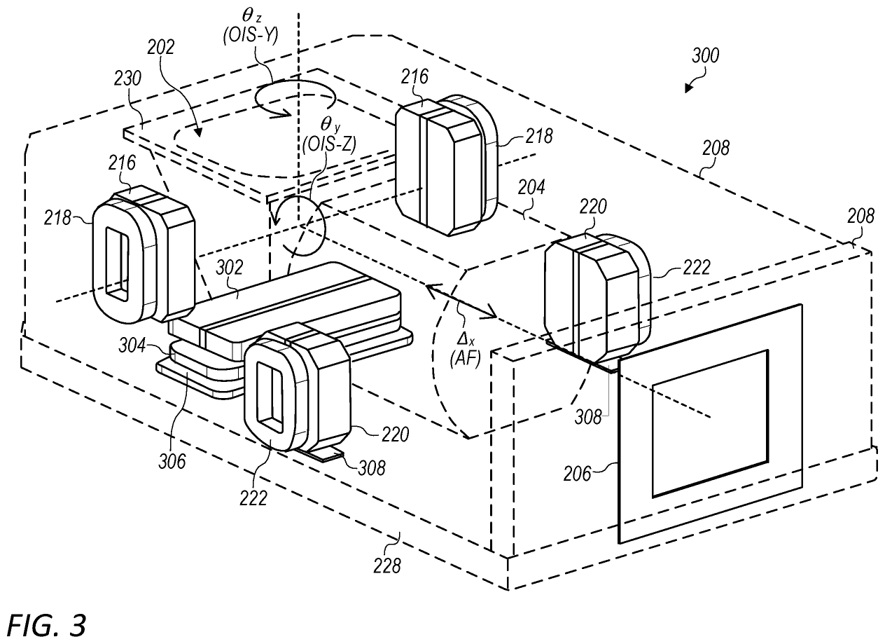

In some embodiments, the OIS-Y VCM actuator may include one or more OIS-Y magnets (e.g., OIS-Y magnets 302 in FIG. 3) and one or more OIS-Y coils (e.g., OIS-Y coils 304 in FIG. 3), e.g., below the prism 202 as indicated in FIG. 3. The OIS-Y magnet(s) may be attached to the Y stage 210 (e.g., a bottom portion and/or underside of the Y stage 210 that faces the floor portion of the base structure 208) and/or to the Z stage 212 (e.g., a bottom portion of the Z stage 212 that faces the floor portion of the base structure 208). Furthermore, the OIS-Y coil(s) may be coupled with the base structure 208 (e.g., a floor portion of the base structure 208). In some embodiments, the OIS-Y coil(s) may be attached to the floor portion of the base structure 208. In some embodiments, the OIS-Y coil(s) may be coupled with the base structure 208 via a flex circuit (e.g., the flex circuit 702 in FIGS. 7A-7B). An OIS-Y magnet and a corresponding OIS-Z coil may be positioned proximate one another so that they magnetically interact with each other to tilt the prism 202 together with the Z stage 212 and the Y stage 210 about Z-axis, to provide OIS-Y movement.

In some embodiments, the AF VCM actuator may include one or more AF magnets 220 and one or more AF coils 222, e.g., as indicated in FIG. 2. The AF magnet(s) 220 may be attached to the X stage 214. Furthermore, the AF coil(s) 222 may be coupled with the base structure 208 (e.g., at lateral side portion(s) of the base structure 208). In some embodiments, the AF coil(s) 222 may be attached to the lateral side portion(s) of the base structure 208. In some embodiments, the AF coil(s) 222 may be coupled with the base structure 208 via a flex circuit (e.g., the flex circuit 702 in FIGS. 7A-7B). An AF magnet 220 and a corresponding AF coil 222 may be positioned proximate one another so that they magnetically interact with each other to translate the lens group 204 together with the X stage 214 along the X-axis, to provide AF movement.

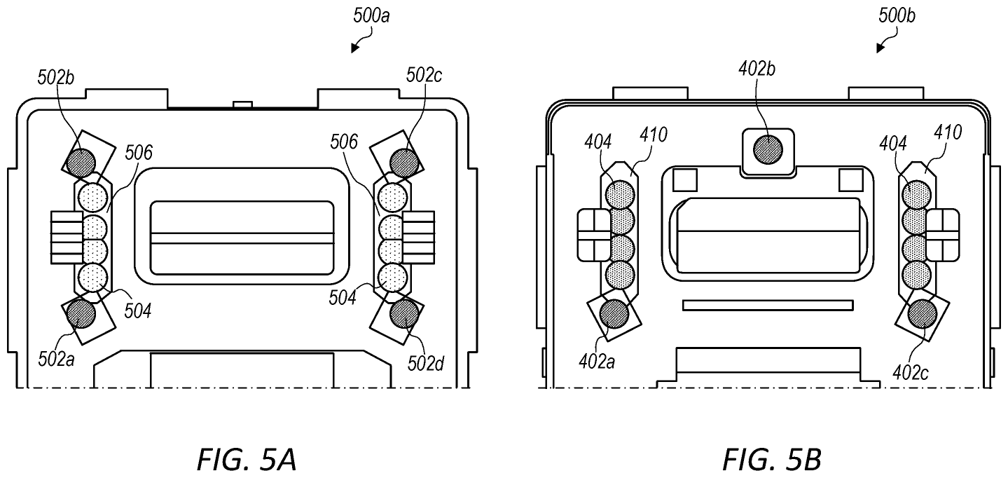

In some embodiments, the camera 200 may include a position sensor arrangement that includes one or more position sensors 224 for position sensing with respect to OIS-Z movement, OIS-Y movement, and/or AF movement. The position sensor(s) 224 may be magnetic field sensors (e.g., Hall sensors, tunneling magnetoresistance (TMR) sensors, giant magnetoresistance (GMR) sensors, etc.) in various embodiments. In some embodiments, a respective position sensor 224 may be located proximate each respective coil of the actuator arrangement. For example, each position sensor 224 may be encircled by a respective coil, as indicated in FIGS. 2 and 5A-5B.

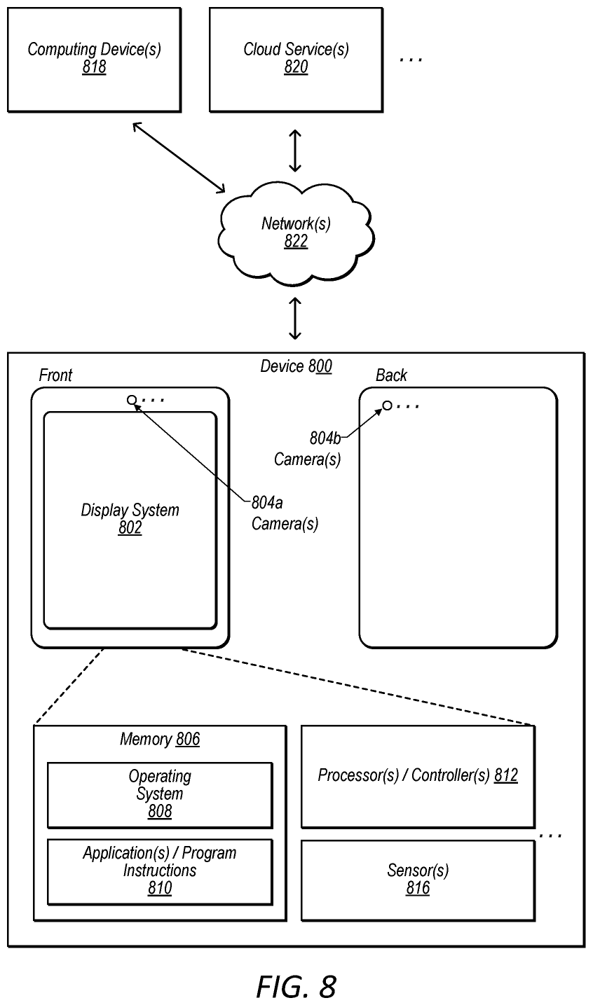

In some embodiments, the base structure 208 may be configured to be packaged around an optical payload (e.g., the folded optics arrangement) on multiple sides. According to some embodiments, one or more other components may be coupled to the base structure 208, such as a shield can (e.g., the shield can 802a in FIG. 8A, the shield can 802b in FIGS. 8B-8D, etc.), a substrate 226 coupled with the image sensor 206, and/or a stiffener 228, etc. The substrate 226 may be configured to hold or otherwise support the image sensor 206.

In some embodiments, the camera 200 may include a cover plate 230 that covers at least a portion of the prism 202. For example, the cover plate 230 may cover a portion of the object side of the prism 202 (the side through which light enters the prism 202). The cover plate 230 may define an aperture that allows light to pass through the cover plate 230 and enter the prism 202.

FIG. 3 illustrates a perspective view of an example actuator arrangement that may be included in a camera 300 with folded optics that may be equipped with a ball bearing suspension arrangement, in accordance with some embodiments. In some embodiments, the actuator arrangement and/or one or more other components of the camera 300 may be similar to, or the same as, the actuator arrangement and/or one or more other components of the camera 200 in FIG. 2. For example, the actuator arrangement may include the OIS-Z VCM actuator, the OIS-Y VCM actuator, and the AF VCM actuator discussed above with reference to FIG. 2 in some embodiments.

According to some embodiments, the OIS-Z VCM actuator may include a first magnet-coil pair and a second magnet-coil pair at opposite sides of the prism 202, e.g., between a respective side of the prism 202 and a respective lateral side of the base structure 208. Each magnet-coil pair may include, e.g., an OIS-Z magnet 216 attached to a side of the Y stage 210, and a corresponding OIS-Z coil 218 coupled with a corresponding lateral side of the base structure 208. In some embodiments, at least a portion of the OIS-Z magnet 216 may be disposed within a recess defined by the Y stage 210, e.g., as indicated in FIG. 2. In some embodiments, the OIS-Z magnet 216 may be a dual-pole magnet. However, the OIS-Z VCM actuator may additionally, or alternatively, include one or more other types of magnets (e.g., single-pole magnet(s)) in various embodiments. In some embodiments, each of the OIS-Z magnet 216 and the OIS-Z coil 218 may have a respective longest dimension that is parallel to the Z-axis. In some embodiments, the OIS-Z coil 218 may be oriented such that current flows through the coil in directions along a plane parallel to the X-Z plane.

According to some embodiments, the OIS-Y VCM actuator may include an OIS-Y magnet 302 and an OIS-Y coil 304 located below the prism 202. In some embodiments, the OIS-Y magnet 302 may be attached to an underside of the Y stage 210, and the OIS-Y coil 304 may be coupled with the base structure 208 (e.g., at a floor portion of the base structure 208, via a flex circuit). According to some non-limiting embodiments, the OIS-Y coil 304 may be attached to a straight portion of the flex circuit. In some embodiments, at least a portion of the OIS-Y magnet 302 may be disposed within a recess defined by the Y stage 210. In some embodiments, the OIS-Y magnet 302 may be a dual-pole magnet. However, the OIS-Y VCM actuator may additionally, or alternatively, include one or more other types of magnets (e.g., sing-pole magnet(s)) in various embodiments. In some embodiments, each of the OIS-Y magnet 302 and the OIS-Y coil 304 may have a respective longest dimension that is parallel to the Y-axis. In some embodiments, the OIS-Y coil 304 may be oriented such that current flows through the coil in directions along a plane parallel to the X-Y plane.

In some embodiments, the AF VCM actuator may include a first magnet-coil pair and a second magnet-coil pair at opposite sides of the lens group 204, e.g., between a respective side of the lens group 204 and a respective lateral side of the base structure 208. Each magnet-coil pair may include, e.g., an AF magnet 220 attached to a side of the X stage 214, and a corresponding AF coil 222 coupled with a corresponding lateral side of the base structure 208. In some embodiments, at least a portion of the AF magnet 220 may be disposed within a recess defined by the X stage 214, e.g., as indicated in FIG. 2. In some embodiments, the AF magnet 220 may be a dual-pole magnet. However, the AF VCM actuator may additionally, or alternatively, include one or more other types of magnets (e.g., single-pole magnet(s)) in various embodiments. In some embodiments, each of the AF magnet 220 and the AF coil 222 may have a respective longest dimension that is parallel to the Z-axis. In some embodiments, the AF coil 222 may be oriented such that current flows through the coil in directions along a plane parallel to the X-Z plane.

In various embodiments, the camera 300 may include one or more ferritic components (e.g., formed of iron, stainless steel, etc.) that may be used to preload one or more of the stages against one or more sets of ball bearings of a bearing suspension arrangement (e.g., the bearing suspension arrangements described herein with reference to at least FIGS. 2 and 4). For example, a ferritic component 306 may be positioned below the OIS-Y magnet 302 to preload the Y stage 210 and/or the Z stage 212 against one or more ball bearings of the bearing suspension arrangement (e.g., Z-tilt ball bearings 402 and/or Y-tilt ball bearings 404 in FIG. 4). In some embodiments, one or more ferritic components 308 may be positioned below the AF magnet(s) 220 to preload the X stage 214 against one or more ball bearings of the bearing suspension arrangement (e.g., the X-translation ball bearings 406 in FIG. 4).

FIG. 4 illustrates a perspective view of an example bearing suspension arrangement that may be included in a camera 400 having folded optics. In some embodiments, the bearing suspension arrangement and/or one or more other components of the camera 400 may be similar to, or the same as, the bearing suspension arrangement and/or one or more other components of the camera 200 in FIG. 2 and/or the camera 300 in FIG. 3.

In some embodiments, the bearing suspension arrangement may include the Y stage 210, the Z stage 212, and/or the X stage 214. In some embodiments, the prism 202 may be coupled with the Y stage 210 and the Z stage 212. Additionally, or alternatively, the lens group 204 may be coupled with the X stage 214.

Furthermore, the bearing suspension arrangement may include one or more ball bearings (e.g., made of steel, ceramic, etc.). In some embodiments, the bearing suspension arrangement may include one or more Z-tilt ball bearings 402, one or more Y-tilt ball bearings 404, and/or one or more X-translation ball bearings 406.

In some other systems (as further described below with reference to FIG. 5A; not shown in FIG. 4) four or more Z-tilt ball bearings are positioned in a single plane orthogonal to the Z-axis. However, in such an arrangement, any small difference in ball size, or for example differences in positional height as a result of imperfect manufacturing tolerances for example in any material surrounding the ball bearings, may reduce the stability of Z stage 212 as it rests and/or rotates on the Z-tilt ball bearings.

FIG. 4 shows a configuration of three Z-tilt ball bearings 402, so arranged to increase stability of Z stage 212 in suspension by Z-tilt ball bearings 402 and during rotating about the Z-axis. In accordance with some embodiments and as shown at FIG. 4, Z-tilt ball bearing 402b is positioned higher (closer to an object side of the prism) on the Z-axis relative to Z-tilt ball bearings 402a and 402c. As a result, and in accordance with some embodiments, the plane formed by ball bearings 402a, 402b, and 402c is not orthogonal to the Z-axis. According to some embodiments, this placement of 402b as shown and/or another of the Z-tilt ball bearings may allow for additional room within a camera housing for more parts and/or upgraded components of a camera module.

In some embodiments, the Z stage 212 may rest on (or otherwise be disposed above) a floor portion of the base structure 208 and may be configured to tilt and/or rotate about the Z-axis, e.g., via Z-tilt ball bearings 402 disposed between the Z stage and the floor portion of the base structure 208. According to some examples, the Z-axis tilt movement may be used to provide the OIS-Y movement previously mentioned with reference to FIG. 1. According to some embodiments, the Z-tilt ball bearings 402 may reside within a Z-tilt track 408 defined, e.g., by the Z stage 212 and/or the base structure 208. As indicated in FIG. 4, for example, an underside of the Z stage 212 may be shaped so as to define one or more grooves, recesses, pockets, etc., that at least partially form the Z-tilt track 408. Additionally, or alternatively, a floor portion of the base structure 208 may be shaped so as to define one or more grooves, recesses, pockets, etc., that at least partially form the Z-tilt track 408. In some embodiments, the Z-tilt ball bearings 402 may be disposed in a space of the Z-tilt track 408 that may be sized to accommodate the Z-tilt ball bearings 402 between the underside of the Z stage 212 and the floor portion of the base structure 208. In various embodiments, the Z-tilt track 408 may be curved (e.g., forming a curve that follows a plane parallel to the X-Y plane) so that movement of the Z stage 212 on the Z-tilt ball bearings 402 along a path of motion allowed by the Z-tilt track 408 provides the Z-axis tilt movement of the Z stage 212 (e.g., together with the Y stage 210 and the prism 202). In some embodiments, the Z-tilt track 408 may comprise multiple segments. For example, as indicated in FIG. 4, the Z-tilt track 408 may comprise two segments that are opposite one another with respect to the prism 202. In other embodiments, however, the Z-tilt track 408 may comprise a single contiguous track.

In some embodiments, the Y stage 210 may rest on (or otherwise be disposed above) the Z stage 212 and may be configured to tilt (and/or rotate) about the Y-axis, e.g., via Y-tilt ball bearings 404 disposed between the Y stage 210 and the Z stage 212. According to some embodiments, the Y-axis tilt movement may be used to provide the OIS-Z movement previously mentioned with reference to FIG. 1. According to some embodiments, the Y-tilt ball bearings 404 may reside within a Y-tilt track 410 defined, e.g., by the Y stage 210 and/or the Z stage 212. As indicated in FIG. 4, for example, an underside of the Y stage 210 may be shaped so as to define one or more grooves, recesses, pockets, etc., that at least partially form the Y-tilt track 410. Additionally, or alternatively, an upper portion of the Z stage 212 may be shaped so as to define one or more grooves, recesses, pockets, etc., that at least partially form the Y-tilt track 410. In some embodiments, the Y-tilt ball bearings 404 may be disposed in a space of the Y-tilt track 410 that may be sized to accommodate the Y-tilt ball bearings 404 between the underside of the Y stage 210 and the upper portion of the Z stage 212. In various embodiments, the Y-tilt track 410 may be curved (e.g., forming a curve that follows a plane parallel to the X-Z plane) so that movement of the Y stage 210 on the Y-tilt ball bearings 404 along a path of motion allowed by the Y-tilt track 410 provides the Y-axis tilt movement of the Y stage 210 (e.g., together with the prism 202). In some embodiments, the Y-tilt track 410 may comprise multiple segments. For example, as indicated in FIG. 4, the Y-tilt track 410 may comprise two segments that are opposite one another with respect to the prism 202. In other embodiments, however, the Y-tilt track 410 may comprise a single contiguous track.

In some embodiments, the X stage 214 may rest on (or otherwise be disposed above) a floor portion of the base structure 208, and may be configured to translate along the X-axis, e.g., via X-translation ball bearings 406 disposed between the X stage 214 and the floor portion of the base structure 208. According to some embodiments, the X-axis translation movement may be used to provide the AF movement previously mentioned with reference to FIG. 1. In various embodiments, the lens group 204 may be coupled to the X stage 214, e.g., such that the lens group 204 moves together with the X stage 214. According to some embodiments, the X-translation ball bearing 406 may reside within an X-translation track 412 defined, e.g., by the X stage 214 and/or the base structure 208. As indicated in FIG. 4, for example, an underside of the X stage 214 may be shaped so as to define one or more grooves, recesses, pockets, etc., that at least partially form the X-translation track 412. Additionally, or alternatively, a floor portion of the base structure 208 may be shaped so as to define one or more grooves, recesses, pockets, etc., that at least partially form the X-translation track 412. In some embodiments, the X-translation ball bearings 406 may be disposed in a space of the X-translation track 412 that may be sized to accommodate the X-translation ball bearings 406 between the underside of the X stage 214 and the floor portion of the base structure 208. In various embodiments, the X-translation track 412 may be straight (e.g., parallel to the X-axis) so that movement of the X stage 214 on the X-translation ball bearings 406 along a path of motion allowed by the X-translation track 412 provides the X-axis translation movement of the X stage 214 (e.g., together with the lens group 204). In some embodiments, the X-translation track 412 may comprise multiple segments. For example, as indicated in FIG. 4, the X-translation track 412 may comprise two segments that are opposite one another with respect to the lens group 204. In other embodiments, however, the X-translation track 412 may comprise a single contiguous track.

FIGS. 5A-5B illustrate top views of example bearing suspension arrangements that may be included in a camera with folded optics. FIG. 5A shows an arrangement 500a having four Z-tilt ball bearings 502a-502d. FIG. 5A further illustrates a plurality of Y-tilt ball bearings 504 in two Y-tilt tracks 506. In the arrangement 500a, all of the four or more Z-tilt bearings 502 may typically be positioned within a plane orthogonal to the direction in which light enters a prism, and parallel to an exterior-facing face of the prism. However, in such an arrangement, any small difference in ball size, or for example differences in positional height as a result of imperfect manufacturing tolerances for example in any material surrounding the ball bearings, may reduce the stability of Z stage 212 as it rests on the Z-tilt ball bearings. However, a three-point ball bearing suspension system, for example, would not be susceptible to the negative effects caused by any such imperfections.

FIG. 5B shows an arrangement 500b including three Z-tilt ball bearings 402a, 402b, and 402c, in accordance with some embodiments. FIG. 5B further illustrates a plurality of Y-tilt ball bearings 404 in two Y-tilt tracks 410. The three Z-tilt ball bearings 402a, 402b, and 402c may be so arranged to increase stability of a Z stage tiltable structure while in suspension by Z-tilt ball bearings 402 and during rotation about the Z-axis. In accordance with some embodiments, the three ball bearings 402 may form any type of triangle, for example an equilateral triangle, an isosceles triangle, a right triangle, an acute triangle, a scalene triangle, or an obtuse triangle. In accordance with some embodiments, a tiltable structure suspended by Z-tilt ball bearings 402a, 402b, and 402c may be similar or identical to a Z stage 212 as shown in FIG. 4 and described above. According to some embodiments, when viewed from the top, a tiltable structure or any other structure suspended by Z-tilt may be positioned such that its center of gravity is within the triangle formed by Z-tilt ball bearings 402a, 402b, and 402c.

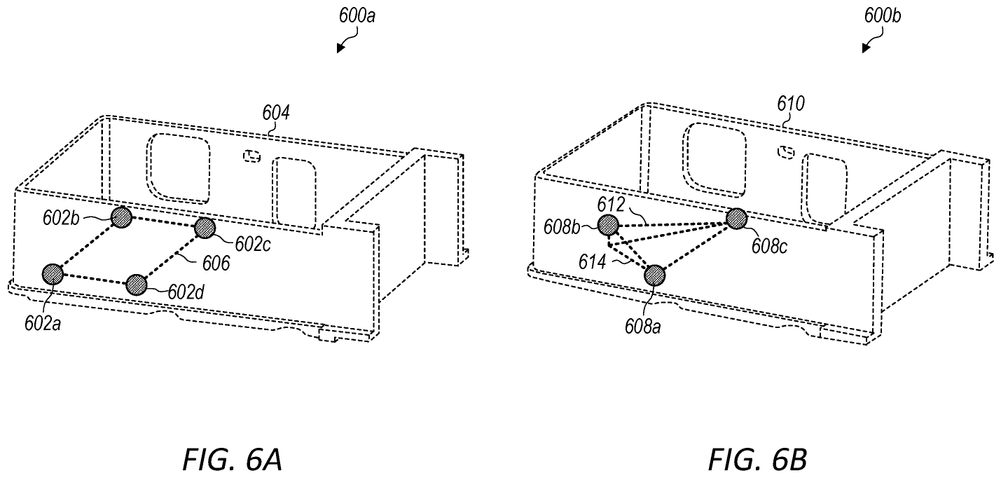

FIGS. 6A-6B illustrate perspective views of the relative positions of bearings in example bearing suspension arrangements that may be included in a camera with folded optics. FIG. 6A shows an arrangement 600a having four Z-tilt ball bearings 602a-602d positioned without a camera housing 604. In some such systems, four or more bearings may be positioned in a single plane 606 orthogonal to an initial optical axis. However, in such an arrangement, any small difference in ball size, or for example differences in positional height as a result of imperfect manufacturing tolerances for example in any material surrounding the ball bearings, may reduce the stability of a tiltable structure as it rests and/or rotates on the Z-tilt ball bearings.

FIG. 6B shows an arrangement 600b of three Z-tilt ball bearings 608a-609c positioned within a camera housing 610, in accordance with some embodiments. According to some embodiments and as show in FIG. 6B, Z-tilt ball bearing 608b is positioned higher on the Z-axis, or closer to an object side of a prism (not shown at FIG. 6B, but substantially similar to prism 102 of FIG. 1) relative to Z-tilt ball bearings 608a and 608c. As a result, and in accordance with some embodiments, the plane 612 formed by ball bearings 608a, 608b, and 608c is positioned at an angle above plane 614 which is orthogonal to the Z-axis, where Z-axis is parallel to the original optical path.

In some embodiments, a tiltable structure such as a prism or mirror (not shown at FIG. 6B) may rest on or otherwise be disposed above Z-tilt ball bearings 608a-608c and may be configured to tilt and/or rotate about the Z-axis.

FIGS. 7A-7B illustrate partial cross-sectional views of example folded optics arrangements that may include a ball bearing suspension arrangement. FIG. 7A shows a view of an arrangement 700a that may be used, e.g., with the ball bearing suspension arrangement(s) shown in FIG. 5A and/or FIG. 6A. FIG. 7B shows another arrangement 700b that includes a housing with a modified wall thickness for accommodating one or more ball bearings, in accordance with some embodiments.

In FIG. 7A, the arrangement 700a may include a flex circuit 702 (e.g., a VCM flex) that may be folded to wrap around at least a portion of a housing 704a (and/or base structure) of the camera. A lower portion of the housing 704a (e.g., the portion surrounded by the broken rectangle in FIG. 7A) may have a wall thickness that is too thin to accommodate a ball bearing, without also making a clearance cut in the flex circuit 702. Such a clearance cut may reduce the space for trace routing on the flex circuit 702, and may thus be undesirable in some cases.

In FIG. 7B, the arrangement 700b may include the flex circuit 702 and a housing 704b with a modified wall thickness to accommodate a ball bearing 706. In some embodiments, the ball bearing 706 may be included in ball bearing suspension arrangements, such as those shown in FIG. 5B and/or FIG. 6B. For example, the ball bearing 706 may correspond to ball bearing 402b (in FIGS. 4 and 5B) and/or ball bearing 608b in FIG. 6B. According to some embodiments, a lower portion of the housing 704b (e.g., the portion surrounded by the broken rectangle in FIG. 7B) may be modified, e.g., with respect to wall thickness and/or wall shape, to accommodate the ball bearing 706 without having to make a cut in the flex circuit 702. In the example shown in FIG. 7B, the housing's 704b wall thickness may be increased at certain portions to accommodate the ball bearing 706 (which, as previously mentioned, may correspond to ball bearing 402b) in a raised position, relative to other ball bearings (e.g., Z-tilt ball bearings 402a and 402c) used to tilt a structure (e.g., Z-stage 708) about a same axis (e.g., the Z-axis). In some embodiments, this positioning of the ball bearing 706, besides enhancing stability for Z-axis rotation and/or tilt, will allow additional space for further components or upgraded components to be built inside the camera module.

FIG. 8 illustrates a schematic representation of an example device 800 that may include a camera with folded optics that may be equipped with a ball bearing suspension arrangement, in accordance with some embodiments. In some embodiments, the device 800 may be a mobile device and/or a multifunction device. In various embodiments, the device 800 may be any of various types of devices, including, but not limited to, a personal computer system, desktop computer, laptop, notebook, tablet, slate, pad, or netbook computer, mainframe computer system, handheld computer, workstation, network computer, a camera, a set top box, a mobile device, an augmented reality (AR) and/or virtual reality (VR) headset, a consumer device, video game console, handheld video game device, application server, storage device, a television, a video recording device, a peripheral device such as a switch, modem, router, or in general any type of computing or electronic device.

In some embodiments, the device 800 may include a display system 802 (e.g., comprising a display and/or a touch-sensitive surface) and/or one or more cameras 804. In some non-limiting embodiments, the display system 802 and/or one or more front-facing cameras 804a may be provided at a front side of the device 800, e.g., as indicated in FIG. 8. Additionally, or alternatively, one or more rear-facing cameras 804b may be provided at a rear side of the device 800. In some embodiments comprising multiple cameras 804, some or all of the cameras may be the same as, or similar to, each other. Additionally, or alternatively, some or all of the cameras may be different from each other. In various embodiments, the location(s) and/or arrangement(s) of the camera(s) 804 may be different than those indicated in FIG. 8.

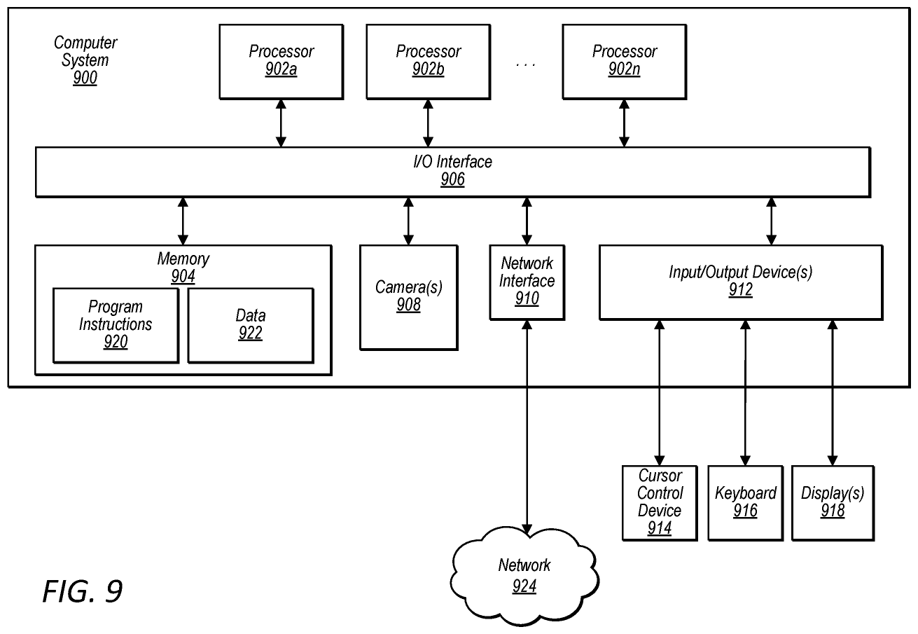

Among other things, the device 800 may include memory 806 (e.g., comprising an operating system 808 and/or application(s)/program instructions 810), one or more processors and/or controllers 812 (e.g., comprising CPU(s), memory controller(s), display controller(s), and/or camera controller(s), etc.), and/or one or more sensors 816 (e.g., orientation sensor(s), proximity sensor(s), and/or position sensor(s), etc.). In some embodiments, the device 800 may communicate with one or more other devices and/or services, such as computing device(s) 818, cloud service(s) 820, etc., via one or more networks 822. For example, the device 800 may include a network interface (e.g., network interface 910 in FIG. 9) that enables the device 800 to transmit data to, and receive data from, the network(s) 822. Additionally, or alternatively, the device 800 may be capable of communicating with other devices via wireless communication using any of a variety of communications standards, protocols, and/or technologies.

FIG. 9 illustrates a schematic block diagram of an example computing device, referred to as computer system 900, that may include or host embodiments of a camera with folded optics that may be equipped with a ball bearing suspension arrangement, in accordance with some embodiments, e.g., as described herein with reference to FIGS. 1-8. In addition, computer system 900 may implement methods for controlling operations of the camera and/or for performing image processing images captured with the camera. In some embodiments, the device 800 (described herein with reference to FIG. 8) may additionally, or alternatively, include some or all of the functional components of the computer system 900 described herein.

The computer system 900 may be configured to execute any or all of the embodiments described above. In different embodiments, computer system 900 may be any of various types of devices, including, but not limited to, a personal computer system, desktop computer, laptop, notebook, tablet, slate, pad, or netbook computer, mainframe computer system, handheld computer, workstation, network computer, a camera, a set top box, a mobile device, an augmented reality (AR) and/or virtual reality (VR) headset, a consumer device, video game console, handheld video game device, application server, storage device, a television, a video recording device, a peripheral device such as a switch, modem, router, or in general any type of computing or electronic device.

In the illustrated embodiment, computer system 900 includes one or more processors 902 (902a-902n) coupled to a system memory 904 via an input/output (I/O) interface 906. Computer system 900 further includes one or more cameras 908 coupled to the I/O interface 906. Computer system 900 further includes a network interface 910 coupled to I/O interface 906, and one or more input/output devices 912, such as cursor control device 914, keyboard 916, and display(s) 918. In some cases, it is contemplated that embodiments may be implemented using a single instance of computer system 900, while in other embodiments multiple such systems, or multiple nodes making up computer system 900, may be configured to host different portions or instances of embodiments. For example, in one embodiment some elements may be implemented via one or more nodes of computer system 900 that are distinct from those nodes implementing other elements.

In various embodiments, computer system 900 may be a uniprocessor system including one processor 902, or a multiprocessor system including several processors 902 (e.g., two, four, eight, or another suitable number). Processors 902 may be any suitable processor capable of executing instructions. For example, in various embodiments processors 902 may be general-purpose or embedded processors implementing any of a variety of instruction set architectures (ISAs), such as the x86, PowerPC, SPARC, or MIPS ISAs, or any other suitable ISA. In multip0rocessor systems, each of processors 902 may commonly, but not necessarily, implement the same ISA.

System memory 904 may be configured to store program instructions 920 accessible by processor 902. In various embodiments, system memory 904 may be implemented using any suitable memory technology, such as static random access memory (SRAM), synchronous dynamic RAM (SDRAM), nonvolatile/Flash-type memory, or any other type of memory. Additionally, existing camera control data 922 of memory 904 may include any of the information or data structures described above. In some embodiments, program instructions 920 and/or data 922 may be received, sent or stored upon different types of computer-accessible media or on similar media separate from system memory 904 or computer system 900. In various embodiments, some or all of the functionality described herein may be implemented via such a computer system 900.

In one embodiment, I/O interface 906 may be configured to coordinate I/O traffic between processor 902, system memory 904, and any peripheral devices in the device, including network interface 910 or other peripheral interfaces, such as input/output devices 912. In some embodiments, I/O interface 906 may perform any necessary protocol, timing or other data transformations to convert data signals from one component (e.g., system memory 904) into a format suitable for use by another component (e.g., processor 902). In some embodiments, I/O interface 906 may include support for devices attached through various types of peripheral buses, such as a variant of the Peripheral Component Interconnect (PCI) bus standard or the Universal Serial Bus (USB) standard, for example. In some embodiments, the function of I/O interface 906 may be split into two or more separate components, such as a north bridge and a south bridge, for example. Also, in some embodiments some or all of the functionality of I/O interface 906, such as an interface to system memory 904, may be incorporated directly into processor 902.

Network interface 910 may be configured to allow data to be exchanged between computer system 900 and other devices attached to a network 924 (e.g., carrier or agent devices) or between nodes of computer system 900. Network 924 may in various embodiments include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 910 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 912 may, in some embodiments, include one or more display terminals, keyboards, keypads, touchpads, scanning devices, voice or optical recognition devices, or any other devices suitable for entering or accessing data by one or more computer systems 900. Multiple input/output devices 912 may be present in computer system 900 or may be distributed on various nodes of computer system 900. In some embodiments, similar input/output devices may be separate from computer system 900 and may interact with one or more nodes of computer system 900 through a wired or wireless connection, such as over network interface 910.

Those skilled in the art will appreciate that computer system 900 is merely illustrative and is not intended to limit the scope of embodiments. In particular, the computer system and devices may include any combination of hardware or software that can perform the indicated functions, including computers, network devices, Internet appliances, PDAs, wireless phones, pagers, etc. Computer system 900 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1200 may be transmitted to computer system 1200 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Generally speaking, a computer-accessible medium may include a non-transitory, computer-readable storage medium or memory medium such as magnetic or optical media, e.g., disk or DVD/CD-ROM, volatile or non-volatile media such as RAM (e.g., SDRAM, DDR, RDRAM, SRAM, etc.), ROM, etc. In some embodiments, a computer-accessible medium may include transmission media or signals such as electrical, electromagnetic, or digital signals, conveyed via a communication medium such as network and/or a wireless link.

The methods described herein may be implemented in software, hardware, or a combination thereof, in different embodiments. In addition, the order of the blocks of the methods may be changed, and various elements may be added, reordered, combined, omitted, modified, etc. Various modifications and changes may be made as would be obvious to a person skilled in the art having the benefit of this disclosure. The various embodiments described herein are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations.

The following clauses describe various examples embodiments consistent with the description provided herein.

Clause 1. A camera, comprising:

an optical element;

an image sensor configured to receive light that has passed through the optical element;

an actuator arrangement, comprising:

one or more tiltable structures, the one or more tiltable structures comprising a carrier to which the optical element or the image sensor is fixedly coupled; and

a tilt actuator configured to tilt the one or more tiltable structures about a tilt axis; and

a ball bearing suspension arrangement that suspends the one or more tiltable structures from a base structure and that allows motion of the optical element or the image sensor enabled by the tilt actuator, wherein the ball bearing suspension arrangement comprises a set of ball bearings arranged to allow tilt motion of the one or more tiltable structures about the tilt axis, and wherein the set of ball bearing s comprises:

a first ball bearing and a second ball bearing positioned along an axis, wherein the axis intersects a plane that is orthogonal to the tilt axis.

Clause 2. The camera of clause 1, wherein:

the plane that is orthogonal to the tilt axis is a first plane; and

the set of ball bearings further comprises:

a third ball bearing, wherein the first ball bearing, the second ball bearing, and the third ball bearing are positioned along a second plane that intersects the first plane.

Clause 3. The camera of clause 1, wherein the optical element comprises at least one of:

a lens;

a prism; or

a mirror.

Clause 4. A device, comprising:

one or more processors;

memory storing program instructions executable by the one or more processors to control operations of a camera; and

the camera, comprising:

an optical element;

an image sensor configured to receive light that has passed through the optical element;

an actuator arrangement, comprising:

one or more tiltable structures, the one or more tiltable structures comprising a carrier to which the optical element or the image sensor is fixedly coupled; and

a tilt actuator configured to tilt the one or more tiltable structures about a tilt axis; and

a ball bearing suspension arrangement that suspends the one or more tiltable structures from a base structure and that allows motion of the optical element or the image sensor enabled by the tilt actuator, wherein the ball bearing suspension arrangement comprises a set of ball bearings arranged to allow tilt motion of the one or more tiltable structures about the tilt axis, and wherein the set of ball bearings comprises:

a first ball bearing and a second ball bearing positioned along an axis, wherein the axis intersects a plane that is orthogonal to the tilt axis.

Clause 5. The device of clause 4, wherein:

the plane that is orthogonal to the tilt axis is a first plane; and

the set of ball bearings further comprises:

a third ball bearing, wherein the first ball bearing, the second ball bearing, and the third ball bearing are positioned along a second plane that intersects the first plane.

Clause 6. The device of clause 4, wherein the optical element comprises at least one of:

a lens;

a prism; or

a mirror.

Clause 7. A camera, comprising:

a light path folding element comprising an object side that receives light in a first direction;

a lens group comprising one or more lens elements;

an image sensor configured to receive light that has been folded by the light path folding element, wherein the light has passed through the lens group;

an actuator arrangement, comprising:

one or more tiltable structures, the tiltable structures comprising a carrier to which the light path folding element is fixedly coupled;

a tilt actuator configured to tilt the one or more tiltable structures about a tilt axis, relative to the image sensor; and

a ball bearing suspension arrangement that suspends the one or more tiltable structures from a base structure and that allows motion of the light path folding element enabled by the tilt actuator, wherein the ball bearing suspension arrangement comprises a set of ball bearings arranged to allow tilt motion of the one or more tiltable structures about the tilt axis, and wherein the set of ball bearings comprises:

a first ball bearing; and

a second ball bearing that is positioned closer, relative to the first ball bearing, to the object side of the light path folding element in the first direction.

Clause 8. The camera of clause 7, the ball bearing suspension arrangement further comprising a third ball bearing, wherein:

the first ball bearing and the third ball bearing are positioned within a first plane that is orthogonal to the first direction; and

the first ball bearing, the second ball bearing, and the third ball bearing define a second plane that is positioned at an angle relative to the first plane.

Clause 9. The camera of clause 8, wherein the first ball bearing, the second ball bearing, and the third ball bearing define an equilateral triangle, an isosceles triangle, a right triangle, an acute triangle, a scalene triangle, or an obtuse triangle.

Clause 10. The camera of clause 8, wherein a center of gravity of at least one of the one or more tiltable structures is positioned within a triangle defined by the first ball bearing, the second ball bearing, and the third ball bearing when viewed orthogonally from the second plane.

Clause 11. The camera of clause 7, wherein the first ball bearing is closer, relative to the second ball bearing, to the image sensor in a second direction that is orthogonal to the first direction.

Clause 12. The camera of clause 7, wherein the light path folding element comprises one or more of a prism or a mirror.

Clause 13. The camera of clause 7, wherein the actuator arrangement comprises one or more voice coil motor (VCM) actuators.

Clause 14. The camera of clause 13, further comprising:

a flex circuit, comprising:

a plurality of bend portions at which the flex circuit is folded to wrap around at least a portion of the base structure; and

a plurality of straight portions.

Clause 15. The camera of clause 14, wherein the one or more VCM actuators comprise:

a plurality of magnets; and

a plurality of coils, comprising:

a first coil attached to a first straight portion of the plurality of straight portions of the flex circuit, wherein the first coil is capable of electromagnetically interacting with a first magnet of the plurality of magnets to tilt the one or more tiltable structures about a first axis; and

a second coil attached to a second straight portion of the plurality of straight portions, wherein the second coil is capable of electromagnetically interacting with a second magnet of the plurality of magnets to tilt the one or more tiltable structures about a second axis that is orthogonal to the first axis.

Clause 16. A device, comprising:

one or more processors;

memory storing program instructions executable by the one or more processors to control operations of a camera; and

the camera, comprising:

a light path folding element comprising an object side that receives light in a first direction;

a lens group comprising one or more lens elements;

an image sensor configured to receive light that has been folded by the light path folding element, wherein the light has passed through the lens group;

an actuator arrangement, comprising:

one or more tiltable structures, the tiltable structures comprising a carrier to which the light path folding element is fixedly coupled;

a tilt actuator configured to tilt the one or more tiltable structures about a tilt axis, relative to the image sensor; and

a ball bearing suspension arrangement that suspends the one or more tiltable structures from a base structure and that allows motion of the light path folding element enabled by the tilt actuator, wherein the ball bearing suspension arrangement comprises a set of ball bearings arranged to allow tilt motion of the one or more tiltable structures about the tilt axis, and wherein the set of ball bearings comprises:

a first ball bearing; and

a second ball bearing that is positioned closer, relative to the first ball bearing, to the object side of the light path folding element in the first direction.

Clause 17. The device of clause 16, the ball bearing suspension arrangement further comprising a third ball bearing, wherein:

the first ball bearing and the third ball bearing are positioned within a first plane that is orthogonal to the first direction; and

the first ball bearing, the second ball bearing, and the third ball bearing define a second plane that is positioned at an angle relative to the first plane.

Clause 18. The device of clause 17, wherein the first ball bearing, the second ball bearing, and the third ball bearing define an equilateral triangle, an isosceles triangle, a right triangle, an acute triangle, a scalene triangle, or an obtuse triangle.

Clause 19. The device of clause 17, wherein a center of gravity of at least one of the one or more tiltable structures is positioned within a triangle defined by the first ball bearing, the second ball bearing, and the third ball bearing when viewed orthogonally from the second plane.

Clause 20. The device of clause 17, wherein the first ball bearing is closer, relative to the second ball bearing, to the image sensor in a second direction that is orthogonal to the first direction.

Clause 21. The device of clause 16, wherein the light path folding element comprises one or more of a prism or a mirror.

Clause 22. The device of clause 16, wherein the actuator arrangement comprises one or more voice coil motor (VCM) actuators.

Clause 23. The device of clause 22, further comprising:

a flex circuit, comprising:

a plurality of bend portions at which the flex circuit is folded to wrap around at least a portion of the base structure; and

a plurality of straight portions.

Clause 24. The device of clause 23, wherein the one or more VCM actuators comprise:

a plurality of magnets; and

a plurality of coils, comprising:

a first coil attached to a first straight portion of the plurality of straight portions of the flex circuit, wherein the first coil is capable of electromagnetically interacting with a first magnet of the plurality of magnets to tilt the one or more tiltable structures about a first axis; and

a second coil attached to a second straight portion of the plurality of straight portions, wherein the second coil is capable of electromagnetically interacting with a second magnet of the plurality of magnets to tilt the one or more tiltable structures about a second axis that is orthogonal to the first axis.

Clause 25. An optics system, comprising:

a light path folding element comprising an object side that receives light in a first direction;

a lens group comprising one or more lens elements;

an image sensor configured to receive light that has been folded by the light path folding element, wherein the light has passed through the lens group;

an actuator arrangement, comprising:

one or more tiltable structures, the tiltable structures comprising a carrier to which the light path folding element is fixedly coupled;

a tilt actuator configured to tilt the one or more tiltable structures about a tilt axis, relative to the image sensor; and

a ball bearing suspension arrangement that suspends the one or more tiltable structures from a base structure and that allows motion of the light path folding element enabled by the tilt actuator, wherein the ball bearing suspension arrangement comprises a set of ball bearings arranged to allow tilt motion of the one or more tiltable structures about the tilt axis, and wherein the set of ball bearings comprises:

a first ball bearing; and

a second ball bearing that is positioned closer, relative to the first ball bearing, to the object side of the light path folding element in the first direction.

Clause 26. The optics system of clause 25, the ball bearing suspension arrangement further comprising a third ball bearing, wherein:

the first ball bearing and the third ball bearing are positioned within a first plane that is orthogonal to the first direction; and

the first ball bearing, the second ball bearing, and the third ball bearing define a second plane that is positioned at an angle relative to the first plane.

Clause 27. The optics system of clause 26, wherein the first ball bearing, the second ball bearing, and the third ball bearing define an equilateral triangle, an isosceles triangle, a right triangle, an acute triangle, a scalene triangle, or an obtuse triangle.

Clause 28. The optics system of clause 26, wherein a center of gravity of at least one of the one or more tiltable structures is positioned within a triangle defined by the first ball bearing, the second ball bearing, and the third ball bearing when viewed orthogonally from the second plane.

Clause 29. The optics system of clause 25, wherein the first ball bearing is closer, relative to the second ball bearing, to the image sensor in a second direction that is orthogonal to the first direction.

Clause 30. The optics system of clause 25, wherein the light path folding element comprises one or more of a prism or a mirror.

Clause 31. The optics system of clause 25, wherein the actuator arrangement comprises one or more voice coil motor (VCM) actuators.

Clause 32. The optics system of clause 31, further comprising:

a flex circuit, comprising:

a plurality of bend portions at which the flex circuit is folded to wrap around at least a portion of the base structure; and

a plurality of straight portions.

Clause 33. The optics system of clause 32, wherein the one or more VCM actuators comprise:

a plurality of magnets; and

a plurality of coils, comprising:

a first coil attached to a first straight portion of the plurality of straight portions of the flex circuit, wherein the first coil is capable of electromagnetically interacting with a first magnet of the plurality of magnets to tilt the one or more tiltable structures about a first axis; and

a second coil attached to a second straight portion of the plurality of straight portions, wherein the second coil is capable of electromagnetically interacting with a second magnet of the plurality of magnets to tilt the one or more tiltable structures about a second axis that is orthogonal to the first axis.

Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

What is claimed is:

1. A camera, comprising:
an optical element;
an image sensor configured to receive light that has passed through the optical element;
an actuator arrangement, comprising:
one or more tiltable structures, the one or more tiltable structures comprising a carrier to which the optical element or the image sensor is fixedly coupled; and
a tilt actuator configured to tilt the one or more tiltable structures about a tilt axis; and
a ball bearing suspension arrangement that suspends the one or more tiltable structures from a base structure and that allows motion of the optical element or the image sensor enabled by the tilt actuator, wherein the ball bearing suspension arrangement comprises a set of ball bearings arranged to allow tilt motion of the one or more tiltable structures about the tilt axis, and wherein the set of ball bearings comprises:
a first ball bearing and a second ball bearing positioned along an axis, wherein the axis intersects a plane that is orthogonal to the tilt axis.

2. The camera of claim 1, wherein:
the plane that is orthogonal to the tilt axis is a first plane; and
the set of ball bearings further comprises:
a third ball bearing, wherein the first ball bearing, the second ball bearing, and the third ball bearing are positioned along a second plane that intersects the first plane.

3. The camera of claim 1, wherein the optical element comprises at least one of:
a lens;
a prism; or
a mirror.

4. A device, comprising:
one or more processors;
memory storing program instructions executable by the one or more processors to control operations of a camera; and
the camera, comprising:
an optical element;
an image sensor configured to receive light that has passed through the optical element;
an actuator arrangement, comprising:
one or more tiltable structures, the one or more tiltable structures comprising a carrier to which the optical element or the image sensor is fixedly coupled; and
a tilt actuator configured to tilt the one or more tiltable structures about a tilt axis; and
a ball bearing suspension arrangement that suspends the one or more tiltable structures from a base structure and that allows motion of the optical element or the image sensor enabled by the tilt actuator, wherein the ball bearing suspension arrangement comprises a set of ball bearings arranged to allow tilt motion of the one or more tiltable structures about the tilt axis, and wherein the set of ball bearings comprises:
a first ball bearing and a second ball bearing positioned along an axis, wherein the axis intersects a plane that is orthogonal to the tilt axis.

5. The device of claim 4, wherein:
the plane that is orthogonal to the tilt axis is a first plane; and
the set of ball bearings further comprises:
a third ball bearing, wherein the first ball bearing, the second ball bearing, and the third ball bearing are positioned along a second plane that intersects the first plane.

6. The device of claim 4, wherein the optical element comprises at least one of:
a lens;
a prism; or
a mirror.

7. A system, comprising:
a light path folding element comprising an object side that receives light in a first direction;
a lens group comprising one or more lens elements, wherein the light passes through the lens group;
an actuator arrangement, comprising:
one or more tiltable structures, the tiltable structures comprising a carrier to which the light path folding element is fixedly coupled;
a tilt actuator configured to tilt the one or more tiltable structures about a tilt axis; and
a ball bearing suspension arrangement that suspends the one or more tiltable structures from a base structure and that allows motion of the light path folding element enabled by the tilt actuator, wherein the ball bearing suspension arrangement comprises a set of ball bearings arranged to allow tilt motion of the one or more tiltable structures about the tilt axis, and wherein the set of ball bearings comprises:
a first ball bearing; and
a second ball bearing that is positioned closer, relative to the first ball bearing, to the object side of the light path folding element in the first direction.

8. The system of claim 7, the ball bearing suspension arrangement further comprising a third ball bearing, wherein:
the first ball bearing and the third ball bearing are positioned within a first plane that is orthogonal to the first direction; and
the first ball bearing, the second ball bearing, and the third ball bearing define a second plane that is positioned at an angle relative to the first plane.

9. The system of claim 8, wherein the first ball bearing, the second ball bearing, and the third ball bearing define an equilateral triangle, an isosceles triangle, a right triangle, an acute triangle, a scalene triangle, or an obtuse triangle.

10. The system of claim 8, wherein a center of gravity of at least one of the one or more tiltable structures is positioned within a triangle defined by the first ball bearing, the second ball bearing, and the third ball bearing when viewed orthogonally from the second plane.

11. The system of claim 7, wherein the first ball bearing is closer, relative to the second ball bearing, to the image sensor in a second direction that is orthogonal to the first direction.

12. The system of claim 7, wherein the light path folding element comprises one or more of a prism or a mirror.

13. The system of claim 7, wherein the actuator arrangement comprises one or more voice coil motor (VCM) actuators.

14. The system of claim 13, further comprising:
a flex circuit, comprising:
a plurality of bend portions at which the flex circuit is folded to wrap around at least a portion of the base structure; and
a plurality of straight portions.

15. The system of claim 14, wherein the one or more VCM actuators comprise:
a plurality of magnets; and
a plurality of coils, comprising:
a first coil attached to a first straight portion of the plurality of straight portions of the flex circuit, wherein the first coil is capable of electromagnetically interacting with a first magnet of the plurality of magnets to tilt the one or more tiltable structures about a first axis; and
a second coil attached to a second straight portion of the plurality of straight portions, wherein the second coil is capable of electromagnetically interacting with a second magnet of the plurality of magnets to tilt the one or more tiltable structures about a second axis that is orthogonal to the first axis.

16. The system of claim 7, wherein the system is a camera comprising an image sensor configured to receive light that has been folded by the light path folding element, wherein the light has passed through the lens group;.

17. The system of claim 7, further comprising:
one or more processors;
memory storing program instructions executable by the one or more processors to control operations of a camera; and
the camera, comprising:
the light path folding element;
the lens group;
an image sensor configured to receive light that has been folded by the light path folding element, wherein the light has passed through the lens group;
the actuator arrangement, wherein the tilt actuator is configured to tilt the one or more tiltable structures about the tilt axis, relative to the image sensor; and
the ball bearing suspension arrangement.

18. The device of claim 17, the ball bearing suspension arrangement further comprising a third ball bearing, wherein:
the first ball bearing and the third ball bearing are positioned within a first plane that is orthogonal to the first direction; and
the first ball bearing, the second ball bearing, and the third ball bearing define a second plane that is positioned at an angle relative to the first plane.

19. The device of claim 18, wherein the first ball bearing, the second ball bearing, and the third ball bearing define an equilateral triangle, an isosceles triangle, a right triangle, an acute triangle, a scalene triangle, or an obtuse triangle.

20. The device of claim 18, wherein a center of gravity of at least one of the one or more tiltable structures is positioned within a triangle defined by the first ball bearing, the second ball bearing, and the third ball bearing when viewed orthogonally from the second plane.
